(19) United States
(12) Patent Application Publication
(10) Pub. No.: US 2026/0072673 A1
(43) Pub. Date: Mar. 12, 2026

(54) PLATFORM FOR IN-FLIGHT ENTERTAINMENT AND COMMUNICATION

(71) Applicant: Panasonic Avionics Corporation, Irvine, CA (US)

(72) Inventors: Vrajesh MEHTA, La Palma, CA (US); Christopher VANDENBERG, Fullerton, CA (US); Attila SZILAGYI, Santa Ana, CA (US)

(21) Appl. No.: 19/171,117

(22) Filed: Apr. 4, 2025

Related U.S. Application Data
(60) Provisional application No. 63/693,625, filed on Sep. 11, 2024.

(51) Int. Cl. G06F 8/65

(52) U.S. Cl. CPC G06F 8/65

(57) ABSTRACT

Virtualized onboard aircraft platforms for in-flight entertainment and associated systems, devices, and methods are disclosed herein. In some embodiments, an platform comprises an airside platform onboard an aircraft, a development platform, and an operations platform. The airside platform can host applications and store media files via edge caching. The development platform can include (i) a developer portal providing a user interface for applications developers to develop the applications, (ii) a simulator environment configured to simulate the airside platform and test the applications developed via the developer portal, and (iii) a deployment unit configured to deploy the applications developed and tested. The operations platform can provide the media files to the airside platform and monitor each of the airside platform and the development platform. The platform can facilitate development and deployment of the plurality of applications on multiple types of aircrafts while remaining aircraft-agnostic to the application developers.

### CROSS-REFERENCE TO RELATED APPLICATION(S)

The present application claims the benefit of U.S. Provisional Ser. No. 63/693,625, entitled “VIRTUALIZED OPEN DIGITAL PLATFORM FOR IN-FLIGHT ENTERTAINMENT,” filed Sep. 11, 2024, the disclosure of which is incorporated herein by reference in its entirety.

### TECHNICAL FIELD

This document is generally related to systems, methods, and apparatus for providing hardware or software for in-flight entertainment and data connectivity.

### BACKGROUND

Commercial travel has evolved with the increasing popularity of personal electronic devices (PEDs) that passengers carry on board, as well as media player devices provided in commercial passenger vehicles. Furthermore, most modern commercial passenger vehicles include communication and display electronics, commonly referred to as in-flight entertainment and communication (IFEC) equipment.

### SUMMARY

This patent document describes, among other things, a technical solution to implement a service platform for use by application developers, airlines, service providers, passengers during travel, and/or the like. In particular, embodiments of the present technology can provide a neutral and open ecosystem for aircraft OEMs, customers, suppliers, and partners to host diverse digital applications and services. The present technology can ensure seamless integration and robust support for stakeholders. In some embodiments, a service platform, simply abbreviated as platform, includes an airside platform, a development platform, and an operations platform.

The service platform, which may include a software platform, can be compatible with all types (e.g., models, makes, brands) of aircrafts, can be modular, and can incorporate a software development approach that uses the cloud's capabilities to build applications that are scalable, flexible, and easy to manage. The airside platform can allow OEMs, airlines, and third parties to host various digital applications with computing and storage that can be scaled from simple applications for low-cost operators to advanced in-seat entertainment. The development platform can offer OEMS, airlines, and third parties with tools, APIs, documentation, training, simulators, testing, certification, and/or the like to create applications for the platform. In some embodiments, the development platform includes a developer portal, software development kits (SDKs), APIs, virtual aircraft test environments, and continuous integration and continuous development (CI/CD) and testing tools for integration and validation. The operations platform can include applications for managing the platform as a whole, such as application deployment, fleet management, monitoring, and/or the like.

In an aspect, a system for inflight entertainment and connectivity is disclosed. The system includes a first component disposed on an aircraft and configured to provide edge computing resources on the aircraft, a second component a ground station configured to provide a development platform, and a third component configured to control and monitor the system from outside the aircraft.

In another aspect, a method of providing application development environment is disclosed.

In yet another exemplary aspect, the above-described method is embodied in the form of processor-executable code and stored in a computer-readable program medium. The code, upon execution by one or more processors, causes the one or more processors to implement a method described herein.

The above and other aspects and their implementations are described in greater detail in the drawings, the description, and the claims.

### BRIEF DESCRIPTION OF THE DRAWINGS

FIG. 1 shows an example of an in-flight entertainment (IFE) system installed in an airplane based on some implementations of the disclosed technology.

FIG. 2 shows an example block diagram of a computing device based on some implementations of the disclosed technology.

FIG. 3 shows an example of a configuration of are airlines based software environment.

FIG. 4 shows an example of a configuration of another onboard software environment.

FIG. 5 shows an example of ecosystem involved in an onboard aircraft platform for airlines applications.

FIG. 6 shows an example architecture diagram.

FIG. 7 shows an example hosting infrastructure and orchestration.

FIG. 8 show a services integration and application view.

FIG. 9 shows an example architecture for a mobile platform.

FIG. 10 shows an example application management flow.

FIG. 11 shows an example of fleet management architecture.

FIG. 12 shows an example workflow for enabling application development.

FIG. 13 shows an example workflow of an onboard aircraft platform.

FIG. 14 shows an example workflow for deploying production quality software or hardware.

FIG. 15 shows another example workflow for production deployment.

FIG. 16 shows some operational details in an air travel application scenario.

FIG. 17 is a schematic illustrating a Platform-as-a-Service (PaaS) environment configured in accordance with various embodiments of the present technology.

FIG. 18 is a schematic illustrating another PaaS environment configured in accordance with various embodiments of the present technology.

FIG. 19 illustrates how a PaaS environment can respond to hardware failures in accordance with various embodiments of the present technology.

FIG. 20 is a schematic illustrating a developer ecosystem configured in accordance with various embodiments of the present technology.

FIG. 21 is a flowchart illustrating a method for operating a platform for deploying, executing, and managing software services on aircrafts in accordance with various embodiments of the present technology.

### DETAILED DESCRIPTION

Although various embodiments are disclosed with reference to aircraft and aviation networks, the disclosed embodiments may be used on other commercial passenger vehicles such as trains, tourist coaches, ships, and so on. In various embodiments, the term “platform” may refer to a combination of software and hardware, which is defined in terms of its functionality, performance metric and or interfaces to external software and hardware in the form of software application programming interfaces (APIs) and/or hardware compatibility.

### 1. Initial Discussion

Recent advances in wireless technologies have made wireless connection services such as on-board Wi-Fi or Bluetooth connections available during travel in a commercial passenger vehicle such as an airplane or train. Unlike the past when a passenger was not provided with wireless connection services onboard during travel, onboard wireless connection services are available in many commercial vehicles so that passengers can share their trips on social media and business travelers can use their flight time more productively.

A captive portal is an intermediate web page that appears to users seeking to connect to public networks like Wi-Fi hotspots, before they are granted internet access. The captive portal technology is prevalent in public places such as aircraft, airports, hotels, and cafes providing free or paid internet services. The portals serve to authenticate users, display terms of service agreements, collect user data, and manage network access. When users connect and attempt to visit a webpage or use an online resource, their browser is redirected to the portal. Users typically need to undertake an action, such as accepting terms and conditions, entering login credentials, supplying personal data, or making a payment. On completion of these steps, they are granted internet access for a specified duration or until they log out. Portals can enable internet access with bandwidth or time restrictions or monetize the network by offering paid access or advertising-based access. The captive portals are useful in maintaining security measures and preventing unauthorized network access. The current portal process often involves manual intervention, requiring users to actively engage and complete various steps to gain access to the network.

Various entities often offer free and/or paid connectivity options, where free access is limited to essential services (e.g., texting and slow web surfing) and paid access avails higher speeds for various activities (fast web surfing and video streaming). While the idea of free internet access is enticing, it comes with costs absorbed by the connectivity provider and/or their customers (e.g., a hotel). For in-flight or at-sea internet access, these costs are substantially high due to satellite-based connectivity needs. Even conventional (terrestrial) connectivity services (fiber, cable, cellular) involve costs that needs to be accounted for. Some service providers have adopted a sponsorship model, where an advertiser covers the internet access cost in exchange for users viewing an advertisement. However, the current sponsorship model is not yet dynamic, seamless, or automated. Current models used by wireless connection service providers, e.g., Wi-Fi service providers, lack flexibility and scalability, and often hinder seamless connectivity.

In recognition of the limitations of the current sponsorship model and the portals, the disclosed technology provides various implementations to address the above issues and provide dynamic transaction allocation techniques for wireless data connectivity for passengers in a commercial passenger vehicle. Some implementations of the disclosed technology simplify wireless service connectivity by enabling devices to automatically join trusted networks, eliminating the need for frequent manual credential entry, and providing an uninterrupted user experience. Some implementations of the disclosed technology enhance the user experience of joining wireless networks and offer varied cost coverage options for providers, including WIPS, airlines, hotels, cafes, and others. The dynamic transaction allocation techniques can be supported by AI (artificial intelligence) or similar technology, to employ dynamic decision-making capabilities, underpinned by diverse payment sources. The dynamic transaction allocation techniques simplify user experience for passengers while at the same time allow airlines and operators of inflight entertainment (IFE) systems to personalize and prioritize offerings such as data connectivity to passengers.

### 2. Examples of Aircraft Systems

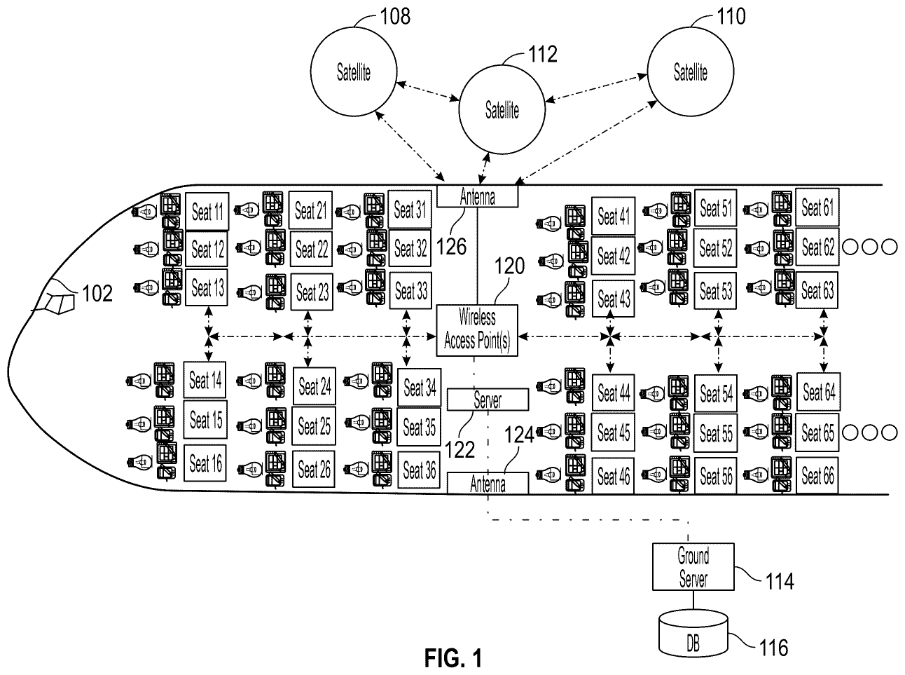

FIG. 1 shows an example of an in-flight entertainment (IFE) system installed in an airplane 102. The IFE system provides various entertainment and connectivity services to passengers on board. Referring to FIG. 1, the IFE system includes a server 122, antenna 126, and antenna 124. The components shown as a single element in FIG. 1 (e.g., the server 122, the wireless access point 120, etc.) can be configured in multiple elements. For example, the in-flight service system can include multiple wireless access points to facilitate or support providing wireless coverages for the passengers. The passengers carry their own devices, which include the PEDs (illustrated by the light bulb icon in FIG. 1) and other wireless electronic devices. The PEDs may refer to any electronic computing device that includes one or more processors or circuitries for implementing the functions related to data storage, video and audio streaming, wired communications, wireless communications, etc. The examples of the PEDs include cellular phones, smart phones, tablet computers, laptop computers, and other portable computing devices. In the implementations of the disclosed technology, the PEDs may have the capability to execute application software programs (“apps”) to perform various functions.

In FIG. 1, the airplane 102 is depicted to include multiple passenger seats, Seat 11 to Seat 66. The media playback devices (illustrated by screen icon) are provided at each passenger seat and configured with capabilities for video and audio streaming, Internet communications, and other capabilities. In some implementations, the media playback devices are provided at each passenger seat, such as located at each of the seatbacks of the passenger seats, and/or on cabin walls and/or deployable from an armrest for seats located at a bulkhead (i.e., in the first row of a section). The media playback devices have displays providing interfaces to each passenger through which each passenger enters his or her selections on the entertainment option, e.g., the particular selections, emergency requests, etc. Upon receiving the selection from the passengers, based on the selections from the passengers, the media playback device displays entertainment content and travel information. In the implementations, to assist the dynamic transaction allocation for the wireless connection services for the passengers, various graphic user interface (GUI) functions can be suggested and displayed on the media playback devices.

The server 122 is communicably coupled with media playback devices and the PEDs and perform various operations including processing requests/inputs from passengers and providing data to passengers. The communications between the server 122 and the passengers'onboard devices including the media playback devices and the PEDs are either realized by wired connections or wireless connections. In some implementations, the communication among the server 122, the media playback devices, and the PEDs are achieved through the antenna 124 to and from the ground-based cell towers by, for example, a provision of network plugs at the seat for plugging PEDs to a wired onboard local area network. In some other implementations, the communications among the server 122, the media playback devices, and the PEDs are achieved through the antenna 126 to and from satellites 108, 110, 112 in an orbit (e.g., via a cellular network utilizing one or more onboard base station(s), Wi-Fi utilizing the wireless access point 120, and/or Bluetooth).

In some implementations, a crew terminal is provided in the airplane 102 utilized by a ground crew, a cabin crew, or a flight crew to access the IFE maintenance functions such as loading new content, replenishing multimedia content digital rights management (DRM) keys, and so on. The crew terminal is in communication with other devices of the IFE system such as the server 122, media playback devices, the PEDs, and the ground server. In some implementations, the crew terminal can be implemented as a part of the server 122. In some implementations, the crew terminal is in communication with the gate terminal to facilitate the dynamic transaction allocation. In some implementations, the gate terminal and the onboard crew terminal store apps to support the dynamic transaction allocation. The gate terminal and the crew terminal are typically accessed by a gate agent or a crew member responsible for overseeing boarding operation. User ID and passwords may be required to authorize the access to the gate terminal and the onboard crew terminal to facilitate identifying of the agent or crew member conducting the boarding operation and to prevent unauthorized access to the system.

The server 122, the media playback devices, and the PEDs form a local network on board the airplane 102 through an onboard router (not shown). The server 122 is also communicably coupled with the ground server 114 through the antenna 126 for receiving and transmitting information from/to the ground server 114. The ground server 114 can be located at various locations, including a gate where passengers check-in the boarding pass right before passengers are on board, a computer center at an arbitrary location on the ground, etc. In some examples, the gate terminal may correspond to the ground server 114 located at the gate and thus can be one example of the ground server 114. The ground server 114 may be in communication with the database 116 and provide information from the database 116 to the server 122 and store information received from the server 122 in the database 116. Although FIG. 1 shows that the database 116 is provided separately from the ground server 114, the database 116 can be provided as a part of the ground server 114.

Although not shown in FIG. 1, the IFE system may further include a database which stores passenger information, for example, profiles of the passengers (name, age, etc.), preferred entertainment options (movies, music, shows, etc.), preferred entertainment content (e.g., genres of movies), etc. The passenger information can be obtained in multiple manners and is stored in the database of the IFE system. In some implementations, the passenger information is obtained prior to the passengers coming on board (e.g., at the time of purchasing the tickets or checking in for the flights), or at other times. In some implementations, the passenger information can be obtained and shared by an association of several airplane companies and retrieved from the database 116. In some implementations, the passenger information can be updated during the travel of the airplane 102.

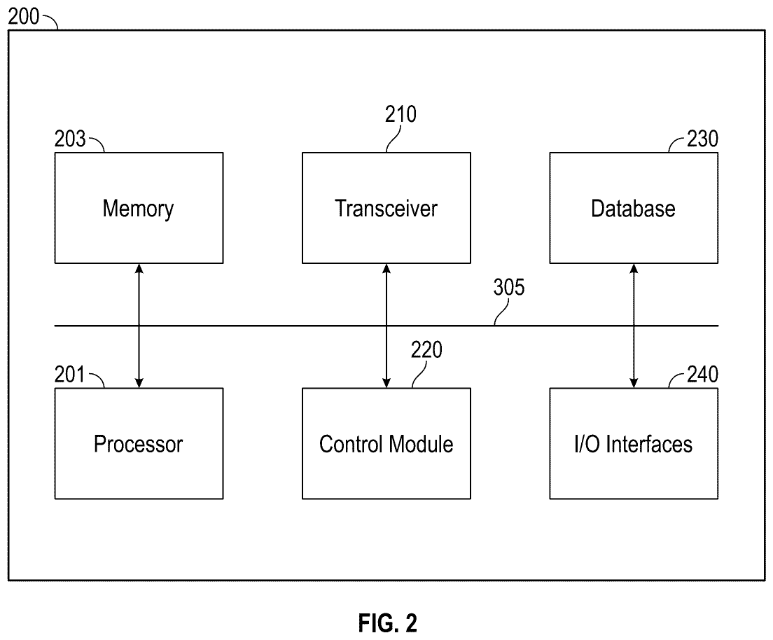

FIG. 2 shows an example block diagram of a computing device (e.g., an onboard server, a PED, a ground server, or a crew terminal) based on some implementations of the disclosed technology. The computing device 200 includes at least one processor 201, a memory 203, a transceiver 210, a control module 220, a database 230, and an input/output (I/O) interface 240, communicating via a bus 305. In other embodiments, additional, fewer, and/or different elements may be used to configure the computing device 200. The memory 203 may store instructions and applications to be executed by the processor 201. The memory 203 is an electronic holding place or storage for information or instructions so that the information or instructions can be accessed by the processor 201. The memory 203 can include, but is not limited to, any type of random access memory (RAM), any type of read-only memory (ROM), any type of flash memory, such as magnetic storage devices (e.g., hard disk, floppy disk, magnetic strips, etc.), optical disks (e.g., compact disc (CD), digital versatile discs (DVD), etc.), smart cards, flash memory devices, etc. The instructions upon execution by the processor 201 configure the computing device 200 to perform the operations, which will be described in this patent document. The instructions executed by the processor 201 may be carried out by a special purpose computer, logic circuits, or hardware circuits. The processor 201 may be implemented in hardware, firmware, software, or any combination thereof. The term “execution” is, for example, the process of running an application or the carrying out of the operation called for by an instruction. The instructions may be written using one or more programming language, scripting language, assembly language, etc. By executing the instruction, the processor 201 can perform the operations called for by that instruction.

The processor 201 operably couples with the memory 203, the transceiver 210, the control module 220, the database 230, and the I/O interface 240, to receive, send, and process information and to control the operations of the computing device 200. The processor 201 may retrieve a set of instructions from a permanent memory device, such as a ROM device, and copy the instructions in an executable form to a temporary memory device that is generally some form of RAM. In some implementations, the computing device 200 can include a plurality of processors that use the same or a different processing technology. The transceiver 210 may include a transmitter and a receiver. In some embodiments, the computing device 200 comprises a transmitter and a receiver that are separate from one another but functionally form a transceiver. The transceiver 210 transmits or sends information or data to another device (e.g., another server, a PED, etc.) and receives information or data transmitted or sent by another device (e.g., another server, a PED, etc.). As will be discussed later, the implementations of the disclosed technology provide data connection services across multiple heterogenous networks including LEO, GEO, and/or MEO, each having a respective authentication, authorization and accounting (AAA) function, by determining a sponsorship for the payment of the data connection services for the pass. The determining of the sponsorship may be based on the type of the transceiver, e.g., whether the airplane has a single channel transceiver or a dual channel transceiver.

The control module 220 of the computing device 200 is configured to perform operations to assist the computing device 200. In some implementations, the control module 220 can be configured as a part of the processor 201. When the computing device 200 corresponds to the IFE system as shown in FIG. 1, the control module 220 can be included in the airplane 102. In some implementations, the control module 220 can operate machine learning/artificial intelligence (AI) applications that perform various types of data analysis to automate analytical model building. Using algorithms that iteratively learn from data, machine learning applications can enable computers to learn without being explicitly programmed. The machine learning/AI module may be configured to use data learning algorithms to build models to interpret various data received from the various devices or components to detect, classify, and/or predict future outcomes. Such data learning algorithms may be associated with rule learning, artificial neural networks, inductive logic programming, and/or clustering. In some implementations, the control module 220 may assist the computing device 200 to perceive their environment and take actions that maximize the effectiveness of the operations performed by the computing device 200.

The I/O interfaces 240 enable data to be provided to the computing device 200 as input and enable the device computing device 200 to provide data as output. In some embodiments, the I/O interfaces 240 may enable user input to be obtained and received by the computing device 200 (e.g., via a touch-screen display, buttons, or switches) and may enable the computing device 200 to display information. In some embodiments, devices, including touch screen displays, buttons, controllers, audio speakers, or others, are connected to the computing device 200 via I/O interfaces 240.

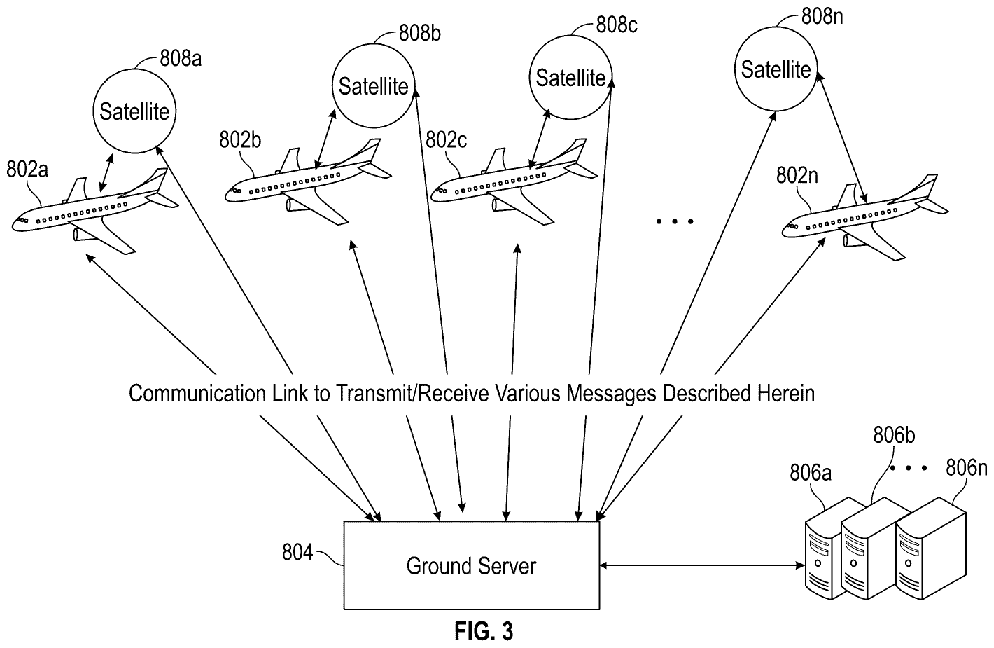

FIG. 3 shows an example of a configuration of a software environment. In the example of FIG. 3, the ground server 804 is located on the ground and communicates with airplanes 802a-802n, satellites 808a-808n, and external servers 806a-806n. Each of the plurality of airplanes 802a-802n includes an IFE system. The IFE systems of the airplanes 802a-802n, the ground server, and the external server 806a to 806n can communicate to exchange data and information to assist the operations/functions of the software platform. For example, an onboard software platform can obtain from the ground server 114 information about passengers and utilize the passenger information to determine sponsorships for wireless connection services for passengers. In some implementations, the ground server 804 works as the source of the user data or operate as an interface to other servers and networks hosting the user data and authentical results. For example, the onboard server can obtain from the ground server 804 information about passengers and store the obtained passenger information in a database. For example, when the airplane is waiting at an airport to board passengers or while passengers are boarding the airplane, the onboard server can obtain from the ground server 804 information about passengers that have boarded or are expected to board the airplane.

The external server 806a-806n may correspond to servers corresponding to different funding sources entities, e.g., airlines, credit card companies, hotels, rental car companies, retails, partner corporates, advertisers, social medias, affiliations, etc. The IFE systems of the airplanes 802a to 802n can communicate directly with the external servers 806a-806n or indirectly with the external servers 806a-806n via the ground server 804. In each airplane, an onboard server can communicate with the ground server 804 and the external server 806a-806n via an antenna directly or through satellites 808a-808n. Although the ground server 804 is shown in FIG. 3 as being located on the ground, the ground server 804 can be located in the cloud or at a remote location. The external servers 806a-806n may be located outside of the airplanes and can communicate with the ground server 804 over the Internet or wired or wireless networks using a variety of communication protocols.

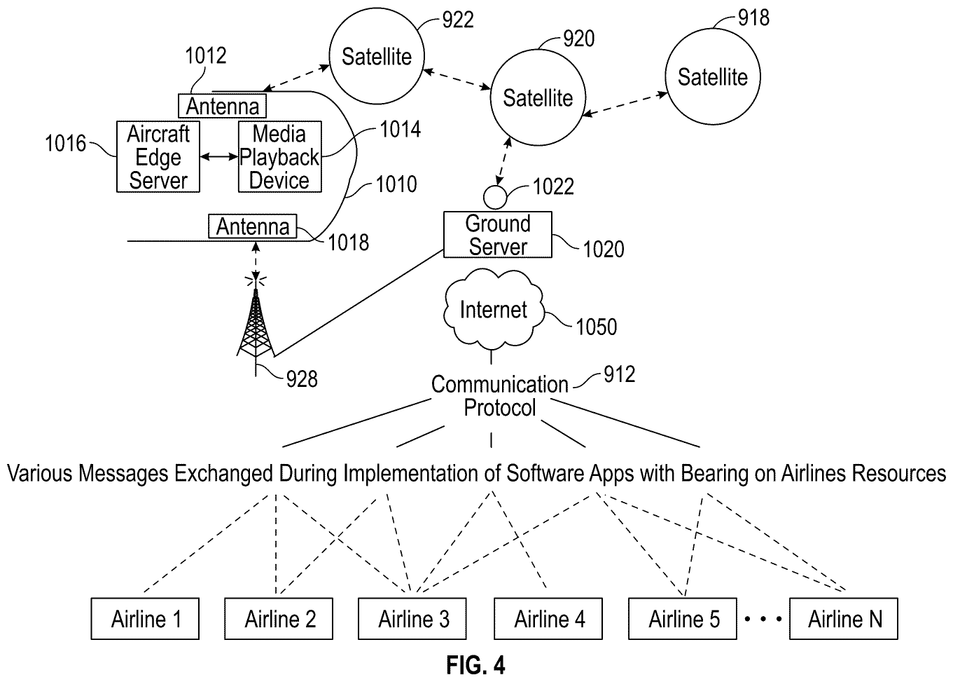

FIG. 4 shows an example of a configuration of an onboard software platform for providing content based on some implementations of the disclosed technology. In the example of FIG. 4, some elements of an airplane 1010 are shown, including antennas 1012 and 1018, a media playback device 1014, and a server 1016 (e.g., an aircraft edge server). The media playback device 1014 can be in communication with the server 1016 and the airplane 1010 can be in communication with a ground server 1020 through the antenna 1012 (on airplane 1010) via one or more satellites 918, 920, 922 and/or a terrestrial communication station 928.

The antenna 1012 may be sized and shaped to fit within the space specified by the relevant standard. For communication with geostationary satellites and providing a satisfactory communication experience for passengers on the airplane, antennas needs to satisfy certain characters related to antenna performance. For example, G/T is a factor typically used for characterizing antenna performance, where G is the antenna gain in decibels in a receive frequency band, and T is the equivalent noise temperature in Kelvins. For example, the antenna 1012 may be configured to provide a certain range of G/T depending on area features during a travel of the airplane 1010. The G/T values are simply provided as examples and are not to be construed as limiting the various adaptive aspects described herein.

For the communications between the ground server 1020 and the airplane 1010, a ground server antenna 1022 is further provided. The ground server 1020 can retrieve data from the airplane 1010 using communication links through the antenna 1012, one or more satellites 918, 920, 922, the ground server antenna 1022, and/or the terrestrial communication station 928. In some implementations, the ground server 1020 can be communicably coupled to the Internet 1050 to retrieve processed data. The Internet 1050 is an example only and other communication protocols 912 can be used to enable the communications between the ground server 1020 and additional servers/platforms.

As shown in FIG. 4, the ground server 1020 can be in further communication with various servers/platforms to obtain various network/operational data, for example, quality of service (QoS) related message including accounting information, auction information, QoS related information, or others. Although the QoS related information is shown in FIG. 4, the QoS is the example of service quality related information. In the implementations, various service quality related information may be utilized without being limited to the QoS related information. The various data can be obtained from various platforms/sources, including multiple airlines, Airlines 1 to N. Although not shown, the machine learning/artificial intelligence module can be employed to cooperate with the ground server 1020 to provide the network/operational data obtained from various servers/platforms. The various servers/platforms can operate as sources of various data that is related to a travel by a commercial passenger vehicle and provide any related information to the ground server 1020 (and/or the machine learning/artificial intelligence module). Such data can be utilized by the ground server 1020 (and/or the machine learning/artificial intelligence module) and communicated with the aircraft edge server 1016 to perform the dynamic transaction allocation.

### 3. Example Ecosystem for an Onboard Aircraft Platform in Air Travel Applications

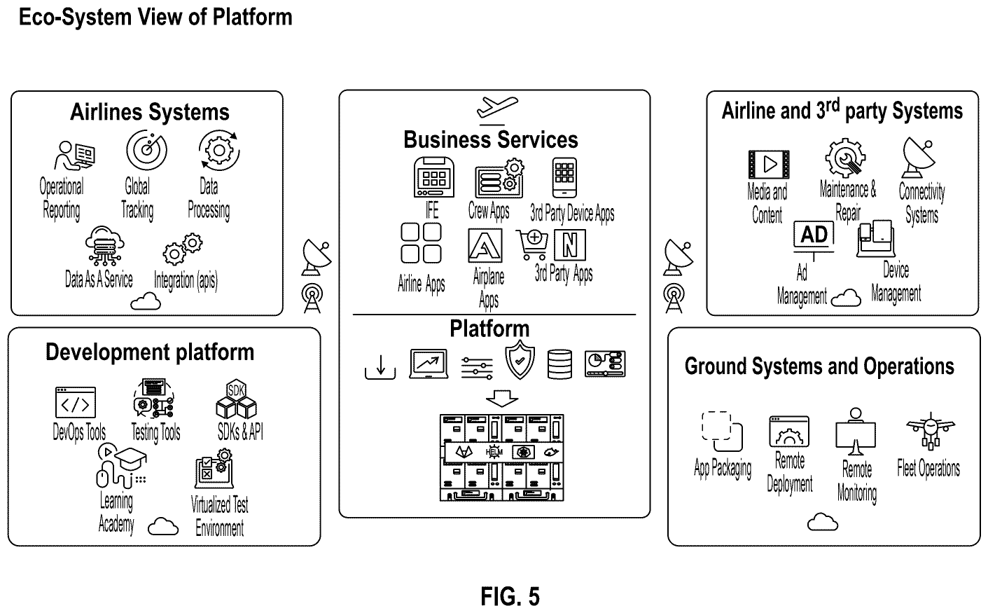

FIG. 5 shows an example of an ecosystem involved in an onboard aircraft platform (OAP) for airlines applications. The center block shows examples of various business services that may be run on the OAP. These services include in-flight entertainment (IFE) apps, crew apps, third party device apps (e.g., passenger electronic devices PED based apps), apps deployed by airlines, apps that are specific to an airplane (e.g., make/model of the airplane) and other third party shopping or other e-commerce apps. The apps may be communicatively connected to various computing platforms in a continuous or “as needed” manner. On the left side are shown various operational apps that may be offered by an airlines system. Such apps or end uses include global tracking of the airplane, data processing apps, operational reporting, data as service offerings and other integration tools. On the left hand side, the OAP may also be in communication with various agents of a development platform including DevOps tools, test tools used for testing, software development kits (SDKs), application programmer interface (API) for a target application, a virtualization test environment and a learning academy. The OAP may also be communicatively connected to airlines and third party system that provide media and content to passenger on airplanes, monitor and perform maintenance or repair tasks, provide communications connectivity, provide an interface for real-time selection of advertisements, and other device management tasks.

### 4. Software Feature Examples

The onboard aircraft platform disclosed in the present document may provide a generic ecosystem of computing system capabilities that enables an airplane manufacturer to provide a digital platform for its suppliers, partners and customer to host varied digital applications. Some example capabilities may include:
Services to host, orchestrate, deploy and monitor applications and services
Data collection and data transport services both real-time, near real-time (micro batch) and batch
System level and data level segregation is ensured with proper tenant management including data privacy are provided
Fleet Management - the ability to remotely deploy and manage application to and on aircrafts
Provide tenant management to meet regulatory, supplier, and airline requirements
   Security services - secure segregation and isolation between different domains (Aircraft, Furniture and IFEC), security of data at rest and in transit, secure access to services hosted by the airplane manufacturer, partners, airlines and suppliers
   IOT/Device enablement
   Provide ability to meter usage of resources and report billing

In addition, some of the features adopted by the OAP implementation include:

### 4.1 Ease of Extensibility

Platform should be modular and extendable to add new capabilities as it evolves, to enable application providers to deploy new applications and services. Here, OAP may make the hardware resources available on an airplane transparent to application providers by providing an interface that ensure that airplane hardware or software changes do not necessitate changes to applications or application programming interfaces (APIs).

### 4.2 Performance and Reliability

Provide an Integrated Digital Platform that has built in performance and reliability. This can be achieved by designing and deploying the system based on well-known APIs and performance metrics that are tested on a variety of different hardware configurations (as disclosed in the present document) and ensuring that application layer performance and end-user experience is maintained across different configurations of hardware and software in an airplane setting.

### 4.3 Open and Extensible

Supports deployment of 3rd party apps that are built using general open-source technologies.

### 4.4 Ease of Provisioning

Easy to provision in the field from a system provider perspective and easy to provision workloads from a consumer perspective.

### 4.5 Ease of Operating

Ease to operate from a day-day perspective, provide intuitive, user-friendly self-service tools and capabilities that enable both platform operator and consumer.

### 4.6 Ease of Monitoring

Provide end-end monitoring - real-time, near real-time and life-cycle or event-based monitoring.

### 4.7 Ease of Maintaining

Provide data driven maintenance tools that enable easy of maintaining. Modular architecture of hardware and software would make it easy to make updates and upgrades.

### 4.8 Ease of Learning

Provide a self-paced learning ecosystem of development tools, sample apps, test environments, trainings and documentation to ease of adoption.

### 4.9 Ease of Metering and Billing

Provide ability to manage allocation and utilization of resources for charge backs and show backs.

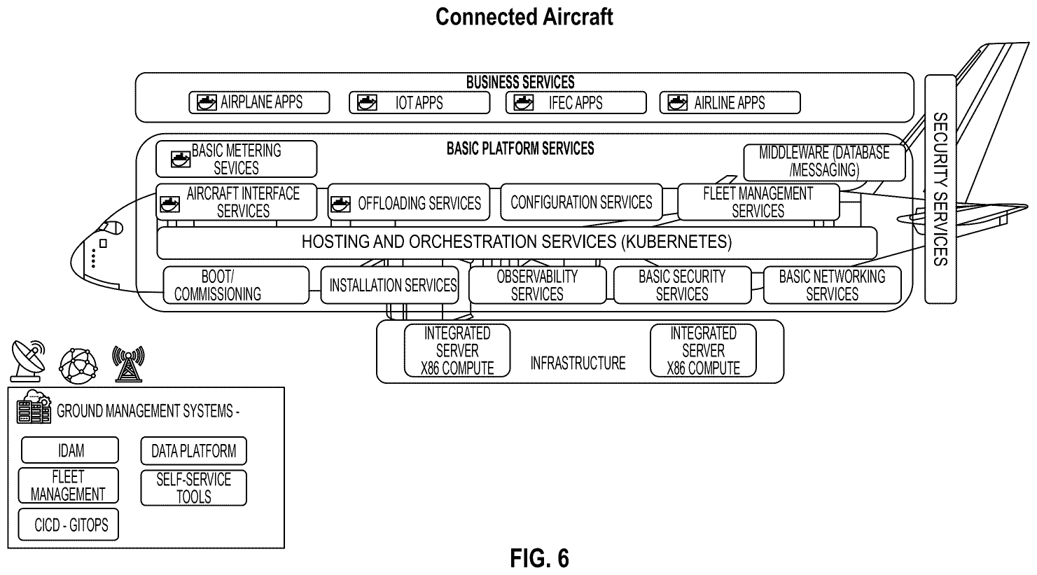

FIG. 6 shows an example architecture diagram of a connected aircraft. The aircraft may be communicating with a ground management system that includes functional building blocks related to management of a fleet of airplanes, and other operational tools. The aircraft may make business services available such as apps specific to an airplane, internet of things (IOT) apps such as sensor measurements, in-flight entertainment apps, and airlines apps. The basic platform includes metering services (e.g., for billing), and other services as depicted.

### 5. Various Architecture Examples

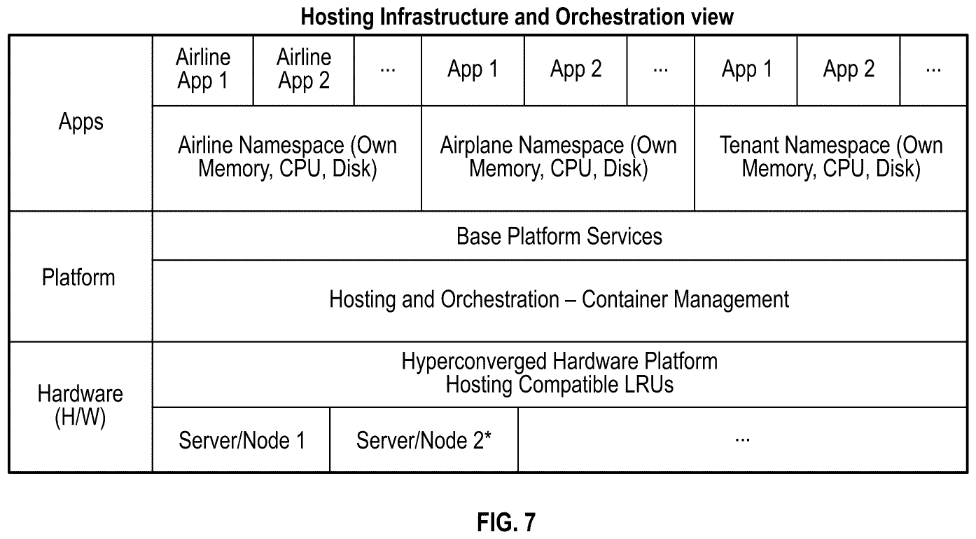

FIG. 7 shows an example hosting infrastructure and orchestration stack. The stack shows three protocol layers—a hardware layer that may comprise one or more server nodes and/or line replacement units (LRU) in the airplane. Above is the OAP layer that provides hosting and orchestration services and other basic platform services to the hardware layer. The top layer includes various apps. The apps may share resources in a non-overlapping manner through mechanisms such as namespace delineation.

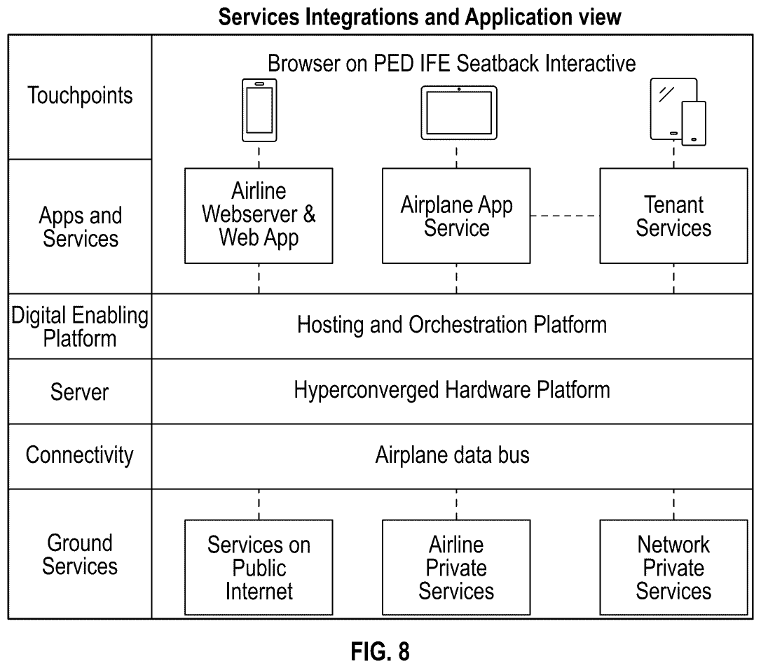

FIG. 8 shows a services integration and application view. As shown in the left-most column, from top to bottom, the services may include touchpoints through which users can access services (e.g., PED, IFE seatback, crew terminal, and so on), various services such as airlines services, e-commerce and other web based services, airplane specific services, airlines specific service, tenant services for which a business pays. The services may be executed on a digital enabling platform that includes a hosting and orchestration layer and a hardware platform. The server hardware may communicate through a backbone connection to other services such as ground based servers, internet based services, private services offered by an airlines, services offered by a network operator, and so on.

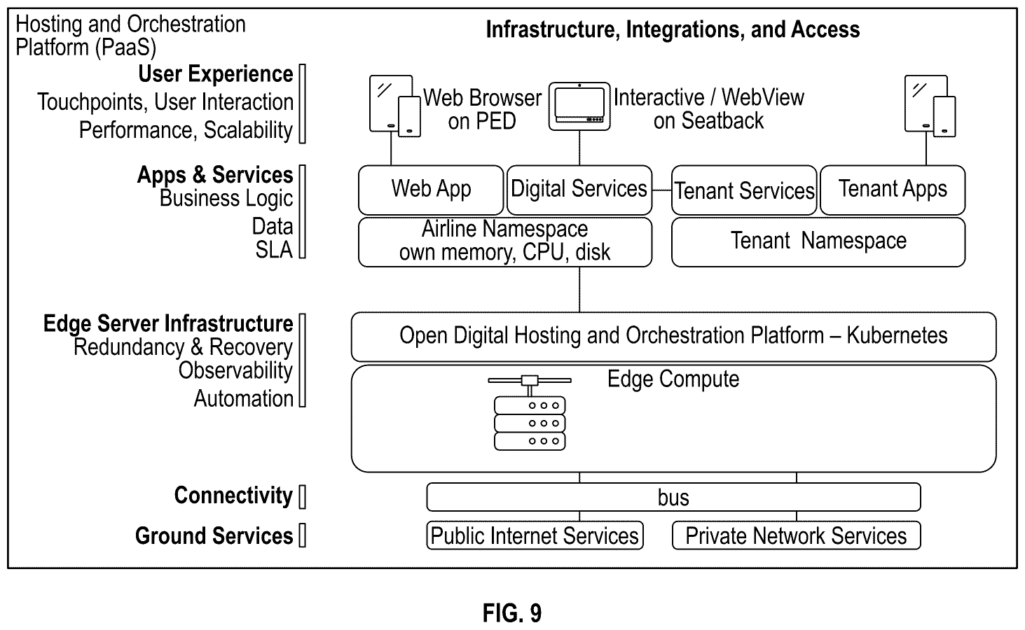

FIG. 9 shows an example architecture for a mobile platform. The architectural details are similar to FIG. 8 with additional details showing available edge computing resources that allow resource utilization at the edge, e.g., in an airplane or a cloud resource close to the airplane. As disclosed in the present document, one of the challenges presented by airplane based service offerings is the unpredictable online/offline connectivity behavior of various services. The use of edge computing platform can advantageously overcome the intermittent connectivity issue.

### 6. Application Deployment Examples

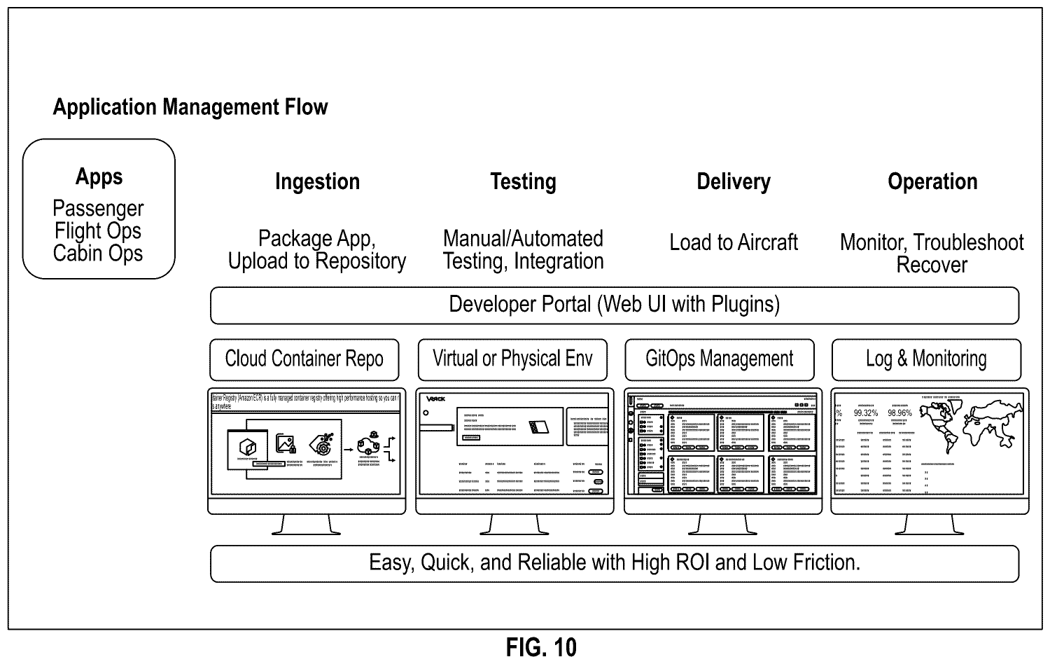

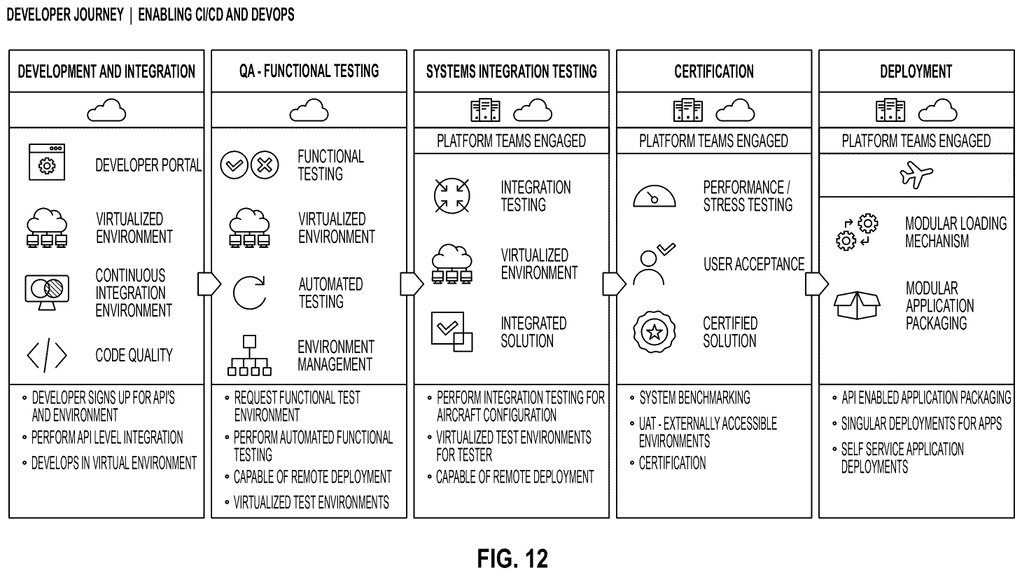

FIG. 10 shows an example application management flow. As shown in the top left block, the workflow may be used for building, testing, and deploying many different types of apps, including passenger apps (e.g., apps which receive user input and provide information to passengers), flight operation apps (e.g., typically used by airlines personnel for ongoing maintenance and operation of a travel segment), and cabin operation apps (e.g., apps that allow crew members in an airplane to control onboard user experiences). Ingestion may occur by packaging the app and uploading it to a repository of apps. Testing may be performed by either manual or automated testing, e.g., using the aforementioned virtualized environment. Delivery may be performed to each aircraft via over the air download and/or through installation performed during maintenance phase. During operation, data may be collected by monitoring app use for troubleshooting. One of the goals of the app design is to minimize a hard reboot of the onboard software environment on the server side because such a task may be cumbersome and may cause flight delays. Therefore, between travel segments (e.g., when passengers are not onboard or are not actively engaged), a state check may be performed on the software environment to ensure that the state matches one or more initial reference states of the software. Different app developers may be able to access the resources of an airplane through a developer portal that may be a web-based tool. For example, in some embodiments, the entire server side software platform with which passengers, crew, airlines and other service agents interact may be considered to be a software defined airplane. Further details are described with reference to FIG. 12.

### 7. Examples of Passenger Experience Enhancements

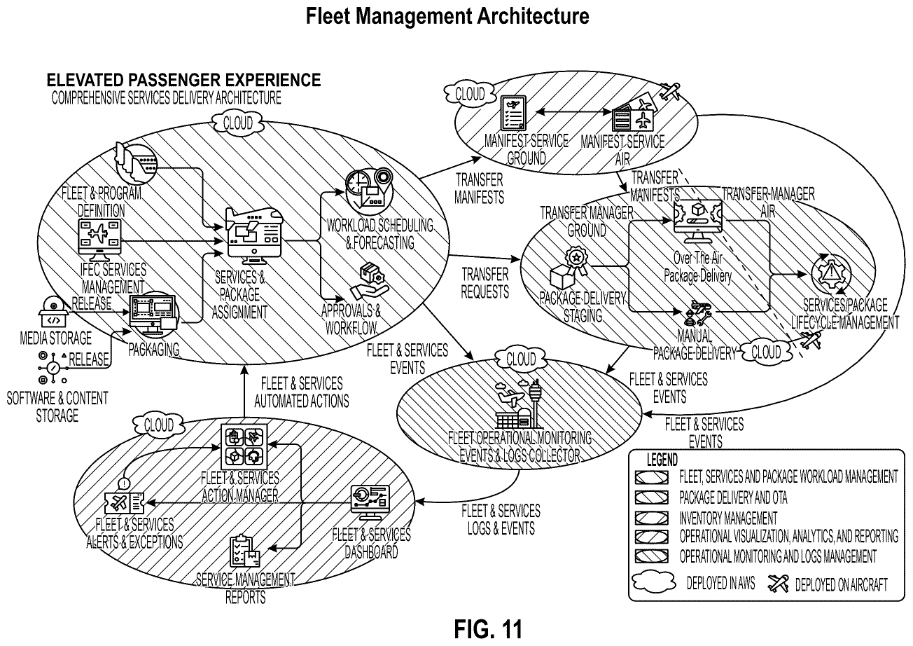

FIG. 11 shows an example of fleet management architecture. Here, an architecture that allows curating and deployment of services such as streaming audio/video content, and other internet based services is disclosed. As depicted, several interactions may occur among resources in the cloud and resources in the airplane. Clockwise from the top left, media may be packaged for consumption on an airplane and may be transferred to a manifest service in the cloud and an airplane based server. A fleet operational monitoring and even log collector may receive information from the package function, and may receive event information from the airplane based service (e.g., who viewed or purchased what titles). This information may be provided to a fleet and service action manager for feeding back information about operational parameters and billing information. A similar workflow may be used to deploy apps that are built using the disclosed modular software platform. Once tested and certified for deployment, the apps may be deployed through the over-the-air mechanism and/or through the storage disk based mechanism like what is used for content. For each app, a corresponding manifest may be provided to an app service function to allow monitoring of deployment and usage of the app. Information regarding the app, such as who used the app, for how long, and whether any in-app purchases were performed, any stoppage issues experienced by the app, and so on, may be collected by the operational monitoring function. This information may be used for quality improvement and for revenue sharing.

FIG. 12 shows an example workflow for enabling application development. Here, various features of the embodiments from a vantage point of an application developer are highlighted. Various tasks are grouped into columns.

### 8. Continuous Integration, Continuous Development (CI/CD) Examples

One feature of the embodiments is to provide developers with a self-service development platform. This is achieved by providing API access to all resources available in the ecosystem, as is described herein. Another way to achieve this is that the development platform provides developers with self-paced training and tutorials. Other resources include sample apps (that work, and that do not work). A general developer flow includes the following steps:
[1] Develop Code using local environment on a desktop or laptop computer
[2] Install required development tools locally
[3] Setup a virtualized environment for the aircraft configuration intended for app or service using development portal
[4] Create CI/CD pipeline to integrate with virtualized environment
[5] Develop Application/Service Code and perform unit testing in local environment
[6] Deploy Application or Service into virtual environment and perform functional and integration testing
[7] Repeat Steps 5 and 6 until application or service is ready for a production deployment.

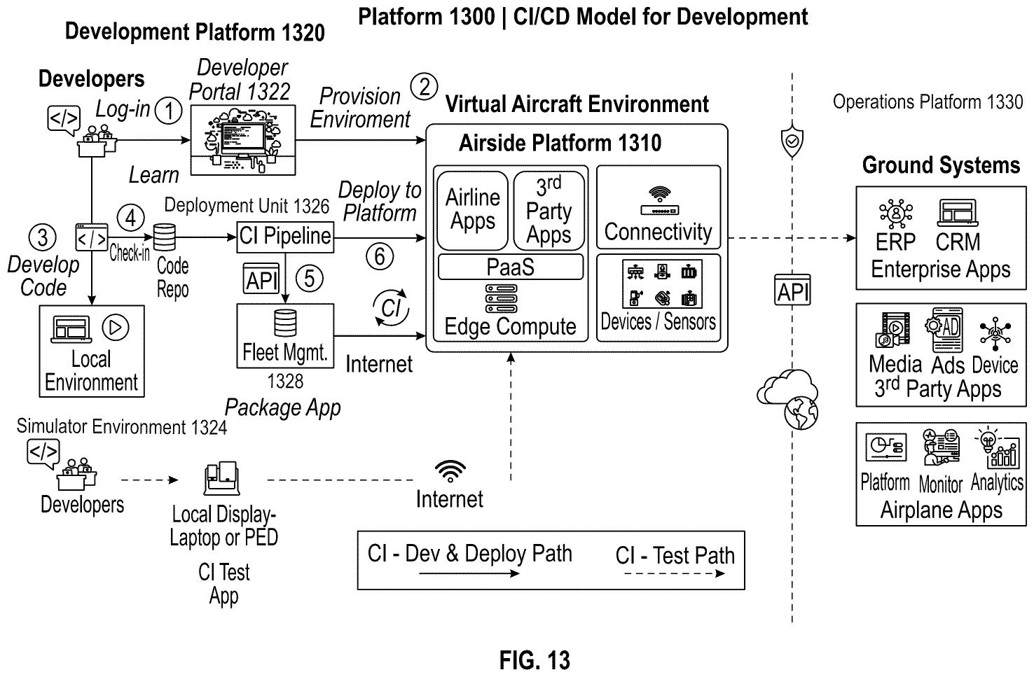

FIG. 13 shows an example workflow of an onboard aircraft platform where the above described steps may be implemented. FIG. 13 is described in greater detail below with reference to solution 8.

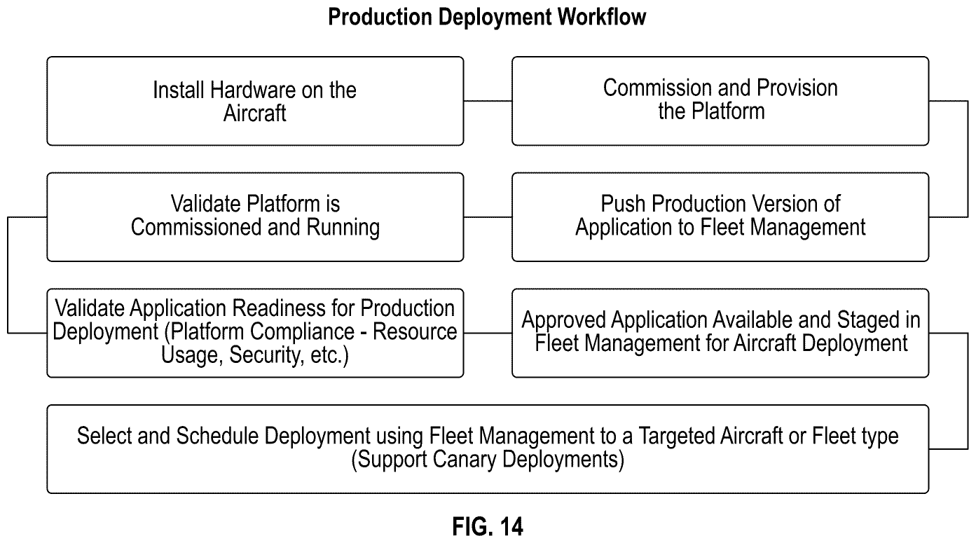

FIG. 14 shows an example workflow for deploying production quality software or hardware. As depicted, the workflow starts with a known hardware configuration of an airplane, up to the step of selected deployment.

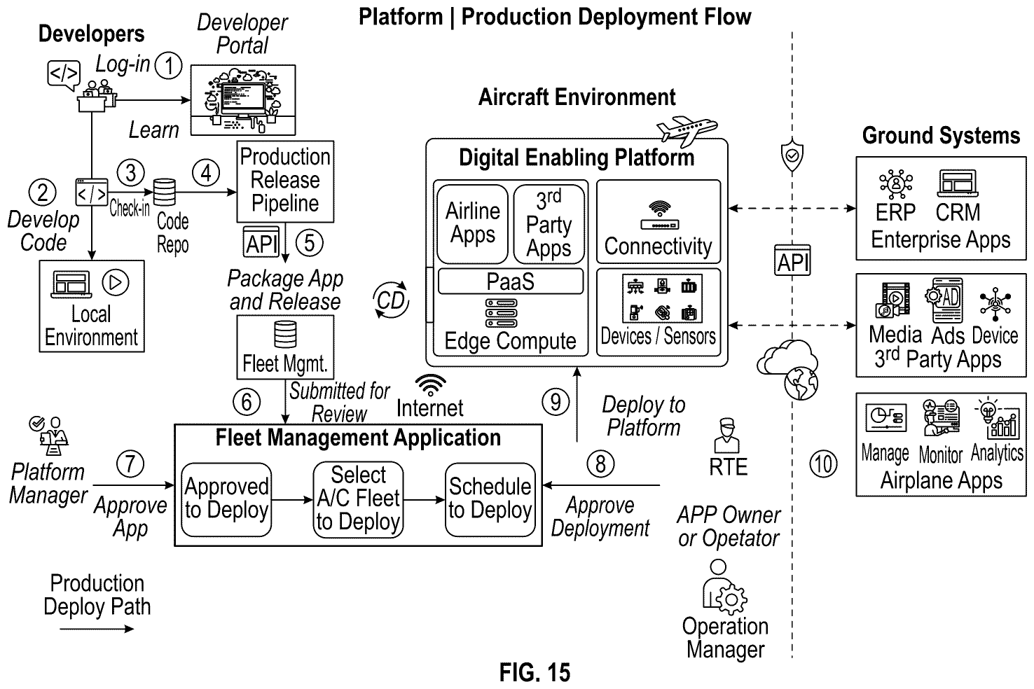

FIG. 15 shows another example workflow for production deployment such as the workflow described with reference to FIG. 14.

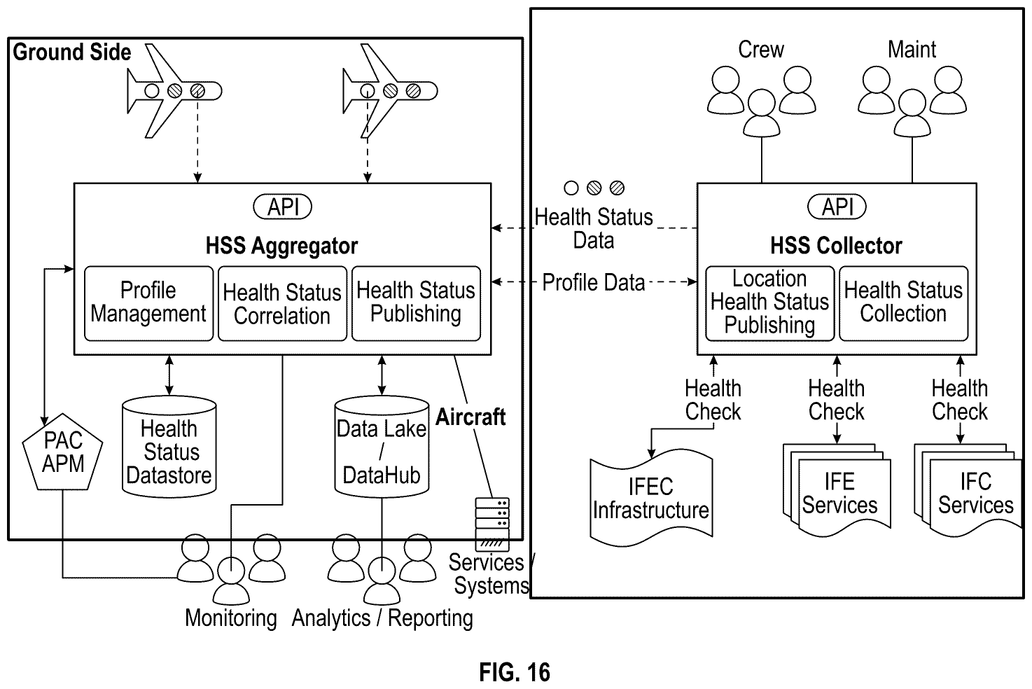

FIG. 16 shows some operational details in an air travel application scenario which highlights certain techniques used for improving maintainability with Health Monitoring and Logging. The following steps may be performed:
[1] Monitor and manage the performance and availability of Air and Ground systems (applications and infrastructure).
[2] Provide simple health status indications of overall aircraft, servers, seat back, airside and ground applications and services—for example: healthy, degraded, or failed
[3] This will significantly reduce MTTD (Mean Time to Detect) helps with RCA and MTTR (Mean Time to Respond) to improve maintainability experience
[4] Facilitate predictive & prescriptive maintenance (mitigate and remediate outages before they occur)
[5] Standardize format of collecting telemetry and monitoring data using OTEL telemetry

In some embodiments, data management strategy may comprise:
[1] Data classifications (Transactional, Device, System, Passenger, etc.)
[2] Data Ownership (Airplane, Airline, IFEC Supplier, Galley/Device provider, 3^{rd} Party providers)
[3] Data Transfer Rate (Real-Time, Near Real Time, Batch, Offline, etc.)
[4] Data Sharing—Data Services, API's, etc.
[5] Data Life Cycle Management—Data Archiving, Backups, etc.
[6] Data Transport—SatCom or Cellular or Wi-Fi
[7] Standardized data collection formats and mechanisms using industry standards such as OTEL.

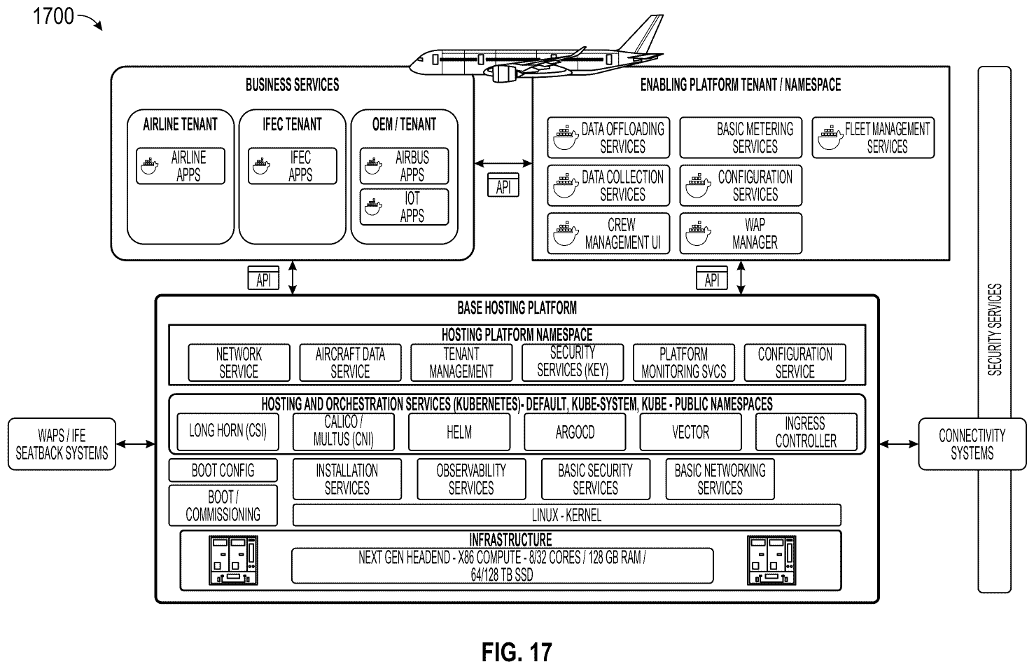

FIG. 17 is a schematic illustrating a Platform-as-a-Service (PaaS) environment 1700 configured in accordance with various embodiments of the present technology. The PaaS environment 1700 can include business services, platform tenant spaces, and a base hosting platform. The business services can include, for example, an airline applications of an airline tenant, IFEC applications of an IFEC tenant, aircraft and/or IOT applications of an OEM tenant, and/or the like, The platform tenant spaces can include, for example, data offloading services, basic metering services, fleet management services, data collection services, configuration services, crew management user interfaces (UIs), WAP managers, and/or the like.

The base hosting platform can include a hosting platform namespace, hosting and orchestration services, factory-installed services, hardware infrastructure, and/or the like. The hosting platform namespace can include network services, aircraft data services, tenant management, security services, platform monitoring services, configuration services, and/or the like. The hosting and orchestration services can include, for example, Long Horn (CSI), Calico/Multus (CNI), HELM, ArgoCD, Vector, Ingress Controller, and/or the like. The factory-installed services can include boot configurations, boot/commissioning, installation services, observability services, basic security services, basic networking services, and/or the like. The hardware infrastructure can include headend servers onboard the aircraft. In some embodiments, the headend servers can include 8/32 cores, 128 GB of RAM, 64/128 TB of SSD, etc. Additional details regarding headend servers are provided in U.S. patent application Ser. No. 19/171,094, titled “SCALABLE AND MODULAR AIRCRAFT SERVER CLUSTER IMPLEMENTATION,” Attorney Docket No. 132056.8801.US01, and filed on Apr. 4, 2025, the disclosure of which is incorporated by reference herein in its entirety. In one advantageous aspect, the platform described herein may be configured to create software-defined storage pools for use various applications, which each module being highly available according to the configuration of the aforementioned headend server. Thermal sensors and airflow sensors will be provided in that design to allow software to scale each nodes power usage to conform to the aircrafts thermal requirement.

Each of the business services, the platform tenant spaces, and the base hosting platform can communicate with one another via APIs. In some embodiments, the base hosting platform can also communicate or otherwise exchange information with WAPs/IFE seatback systems, connectivity systems, and/or the like.

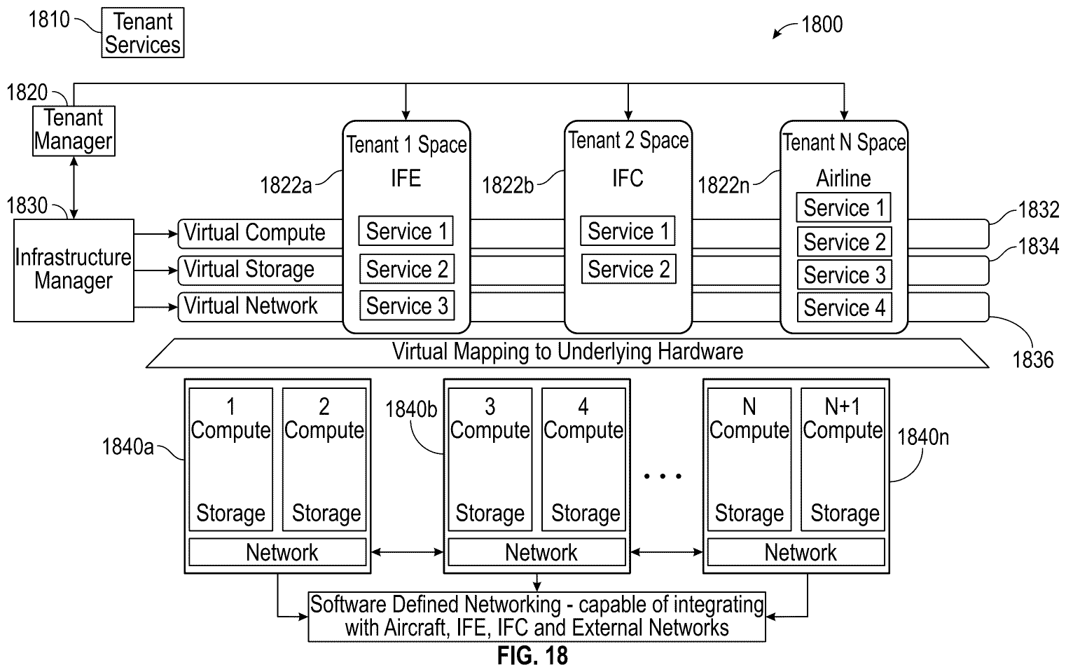

FIG. 18 is a schematic illustrating another PaaS environment 1800 configured in accordance with various embodiments of the present technology. The PaaS environment 1800 can be an example of the PaaS environment 1700 of FIG. 17. As discussed further herein, the PaaS environment 1800 can provide a distributed server-side IFEC computing platform that enables applications to be developed, tested, and run seamlessly in an aircraft IFEC system. The PaaS environment 1800 can include tenant services 1810, a tenant manager 1820, an infrastructure manager 1830, and one or more headend servers 1840a-1840n. The tenant manager 1820 can configure, monitor, and manage a plurality of tenant spaces 1822a-1822n, each of which can host one or more services. For example, the plurality of tenant spaces 1822a-1822n can be dedicated to IFE providers, IFC (inflight communication) providers, airlines, and/or the like. The tenant services 1810 can include various services to be provided to each of the tenant spaces 1822a-1822n, such as flight data, connection statuses, and/or the like.

The infrastructure manager 1830 can configure, monitor, and manage the mapping between the virtualized platform and hardware resources. The virtualized platform can include virtual compute resources 1832, virtual storage 1834, and a virtual network 1836. The headend servers 1840a-1840n can each include one or more compute and/or storage resources and a network module that enables communication with other ones of the headend servers 1840a-1840n. In particular, the network modules of the headend servers 1840a-1840n can provide software defined networking that is capable of integrating with aircraft, IFE, IFC, external networks, and more. The number of headend servers 1840a-1840n can be scaled as needed.

As shown, the plurality of tenant spaces 1822a-1822n can exist overlaid on the virtualized platform, abstracted from physical hardware (e.g., from the headend servers 1840a-1840n). The tenant spaces 1822a-1822n can be secured and isolated from each another. In some embodiments, however, the tenant spaces 1822a-1822n can be bridged via a network (e.g., the virtual network 1836) where needed. The tenant spaces 1822a-1822n can also share or have dedicated portions of the virtual compute resources 1832 and the virtual storage 1834. The tenant manager 1820 and the infrastructure manager 1830 can share information such as various respective states and configurations. As aforementioned, the infrastructure manager 1830 can map the virtual compute resources 1832, the virtual storage 1834, and the virtual network 1836 to the compute, storage, and network resources/modules of the headend servers 1840a-1840n. In some embodiments, the mapping itself remains invisible to the tenant spaces 1822a-1822n.

The PaaS environment 1800 can enable efficient use of available compute, storage, and networking resources while providing horizontal scalability and high performance to host IFE and IFC services. The PaaS environment 1800 can also provide multi-tenancy with highly secure isolation between the tenants that host these applications. The PaaS environment 1800 can also enable configuration of resources using Infrastructure-as-a-Code (IaC) and enable Continuous Integration and Continuous Deployment (CI/CD)-based deployment models for applications using automation. The PaaS environment 1800 can also enable developers to choose any open-source, cloud native, and/or web scale technology stacks to build their applications and integrate them seamlessly into aircraft environments.

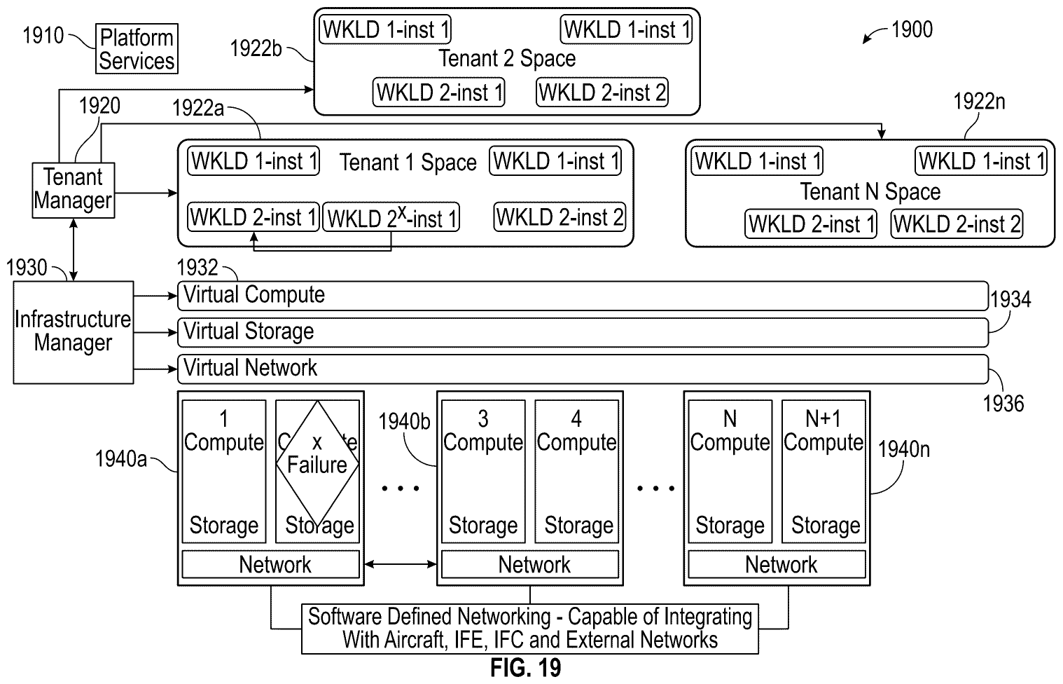

FIG. 19 illustrates how a PaaS environment 1900 can respond to hardware failures in accordance with various embodiments of the present technology. The PaaS environment 1900 can be generally similar to the PaaS environment 1800 of FIG. 18. For example, the PaaS environment 1900 can include tenant/platform services 1910, a tenant manager 1920, an infrastructure manager 1930, and one or more headend servers 1940a-1940n. The tenant manager 1920 can manage a plurality of tenant spaces 1922a-1922n, and the infrastructure manager 1930 can manage virtual compute resources 1932, virtual storage 1934, and a virtual network 1936.

In the illustrated example, the second compute/storage module of the first headend server 1940a has failed. For example, compute blades associated with the second compute/storage module may have been faulty or may have experienced some type of performance failure. Continuing with this example, the infrastructure manager 1930 may have mapped the second workload, first instance (WKLD 2-Inst 1) of the first tenant space 1922a to the second compute/storage module of the first headend server 1940a that failed. In such an event, once the hardware failure has been detected, the infrastructure manager 1930 (or other component) can re-map the virtual compute resources 1932 and/or the virtual storage 1934 to the remaining, functional ones of the compute/storage modules of the headend servers 1940a-1940n. Thus, the infrastructure manager 1930 may reallocate WKLD 2-Inst 1 of the first tenant space 1922a to a different hardware resource that is still functional, such as the first compute/storage module of the first headend server 1940a.

In some embodiments, the reallocation can remain invisible to the tenant spaces 1922a-1922n. Thus, in the event of a hardware failure, the PaaS environment 1900 can respond by reallocating or re-mapping virtual and hardware resources such that the tenant spaces 1922a-1922n can continue to operate without any service interruptions. Moreover, the infrastructure manager 1930 (or other component) can respond to hardware failures in the manner aforementioned without any manual intervention from aircraft crew or maintenance personnel. Such automatic and seamless failover of applications can be particularly important in an aircraft environment in which it can be difficult or undesirable to access the headend servers 1940a-1940n and cause service disruptions to airline customers for IFE and IFC services and/or cause interruptions in airline operations to address hardware failures.

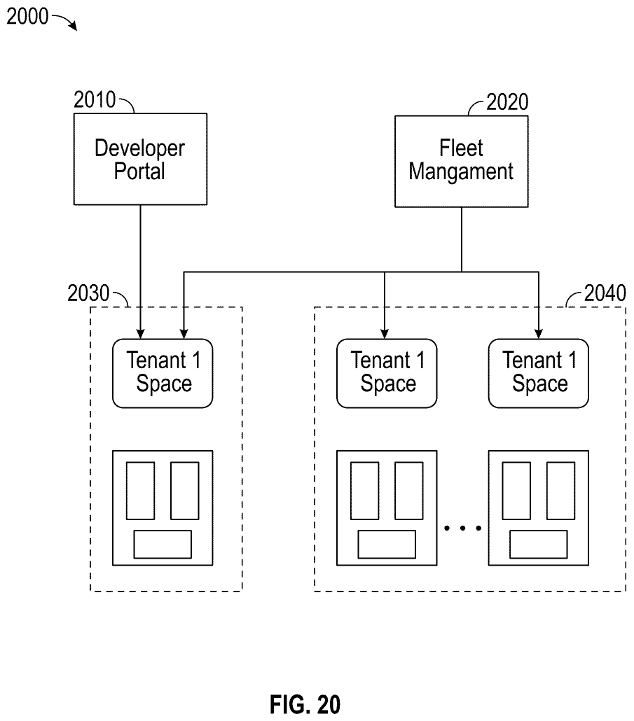

FIG. 20 is a schematic illustrating a developer ecosystem 2000 configured in accordance with various embodiments of the present technology. As discussed further herein, the developer ecosystem 2000 can be associated with the PaaS environments discussed above. In the illustrated embodiment, the developer ecosystem 2000 includes a developer portal 2010, a fleet management resource 2020, a virtual development environment 2030, and an actual aircraft environment 2040. The developer portal 2010 can manage and/or provide tenant resource requests, documentation, tooling, examples, testing, and/or the like to support self-service development in the virtual development environment 2030. The fleet management resource 2020 can manage the deployment of applications developed in the virtual development environment 2030 in the actual aircraft environment 2040. For example, the fleet management resource 2020 can provide live over-the-air (OTA) deployment and monitoring of the applications.

The developer ecosystem 2000 can form a part of the PaaS environments described herein, and can enable developers to easily learn how to develop IFE and IFC applications by leveraging the virtual development environment 2030, the fleet management resource 2020, and/or the like that enable he developers to deploy their applications to one or more aircrafts, thus enabling modern application development models such as Blue-Green, A/B testing, and rolling deployment.

### 9. Example Technical Solutions

Some example technical solutions adopted by some preferred embodiments include:
1. A system for inflight entertainment and connectivity, comprising: a first component disposed on an aircraft and configured to provide edge computing resources on the aircraft, a second component a ground station configured to provide a development platform, and a third component configured to control and monitor the system from outside the aircraft.

Here, the components may comprise a combination of hardware and software, where the hardware may be a computing platform that comprises one or more processors, a memory that stores code for execution by the one or more processors and at least one input-output interface such as a bus or a network connection.
2. The system of solution 1, wherein the development platform is configured to provide application programmers interface to hardware or software resources available to an application while being executed on the aircraft.
3. A method of operating a software platform, comprising: providing an application development platform to a developer of an application targeted to be run on the software platform; certifying the application for execution on the software platform based on the application passing certification testing on the application development platform; and deploying, upon the certifying, the application for execution on the software platform being executed using computing resources onboard an aircraft.
4. The method of solution 3, further including: monitoring the application during execution.
5. The method of any of solutions 3-4, wherein the application development platform comprises software models for a plurality of airplane types such that the software models provide access to computing and hardware resources for the plurality of airplane types via an application programmers interface.
6. The method of any of solutions 3-5, wherein the deploying comprises deploying a given application for execution only under a condition that the given app has been certified through the application development platform.
7. A ground server for controlling software environment on an airplane, configured to implement one or more ground server functionalities disclosed in the present document.
8. A platform 1300 for deploying, executing, and managing software services on an aircraft, the platform comprising: an airside platform 1310 onboard the aircraft, wherein the airside platform is configured to host a plurality of applications and store a plurality of media files via edge caching; a development platform 1320 including: a developer portal 1322 providing a user interface for applications developers to develop the plurality of applications, a simulator environment 1324 configured to simulate the airside platform and test the plurality of applications developed via the developer portal, and a deployment unit 1326 configured to deploy the plurality of applications developed via the developer portal and tested via the simulator environment to the airside platform; and an operations platform 1330 configured to provide the plurality of media files to the airside platform and monitor each of the airside platform and the development platform, wherein the platform is configured to facilitate development and deployment of the plurality of applications on multiple types of aircrafts while remaining aircraft-agnostic to the application developers.
9. The platform of solution 8, wherein the airside platform includes: a plurality of tenant spaces each dedicated to hosting one or more services associated with an in-flight entertainment (IFE) provider, an in-flight communications (IFC) provider, and/or an airline; and a virtual infrastructure including virtual compute resources, virtual storage, and a virtual network, wherein the plurality of tenant spaces operate on the virtual infrastructure.
10. The platform of solution 9, wherein the tenant spaces are secured isolated from one another.
11. The platform of solution 9 or solution 10, wherein the airside platform further includes: a tenant manager configured to configure and monitor the plurality of tenant spaces; and an infrastructure manager configured to configure and monitor the virtual infrastructure.
12. The platform of solutions 8-11, wherein: the aircraft includes a plurality of headend servers, and the airside platform includes: a plurality of tenant spaces each dedicated to hosting one or more services, a virtual infrastructure including virtual compute resources, virtual storage, and a virtual network, wherein the plurality of tenant spaces operate on the virtual infrastructure, and an infrastructure manager configured to map the virtual compute resources, the virtual storage, and the virtual network of the virtual infrastructure onto hardware resources of the plurality of headend servers onboard the aircraft.
13. The platform of solution 12, wherein: the plurality of headend servers including a plurality of compute/storage modules, in an event of a hardware failure of one or more of the plurality of compute/storage modules, the infrastructure manager is configured to reallocate the virtual compute resources, the virtual storage, and the virtual network of the virtual infrastructure onto remaining ones of the plurality of compute/storage modules, and the plurality of tenant spaces remains unaware of the hardware failure.
14. The platform of solutions 8-13, wherein the deployment unit of the development platform includes a fleet management architecture configured to deploy the plurality of applications developed via the developer portal and tested via the simulator environment to multiple airside platforms of multiple different aircrafts via over-the-air (OTA) deployment.
15. The platform of solution 14, wherein the fleet management architecture includes (i) a fleet, services, and package workload management unit, (ii) a package delivery and OTA unit, (iii) an inventory management unit, (iv) an operational visualization, analytics, and reporting unit, and (v) an operational monitoring and logs management unit.
16. The platform of solutions 8-15, wherein the developer portal of the development platform is configured to provide tenant resources, documentation, and/or tooling to the application developers.
17. The platform of solutions 8-16, wherein the development platform includes a plurality of software models corresponding to the multiple types of aircrafts, and wherein the platform is configured to facilitate the development and deployment of the plurality of applications on the multiple types of aircrafts by accessing computing and hardware resources of the multiple types of aircrafts via one or more application programming interfaces associated with the plurality of software models.

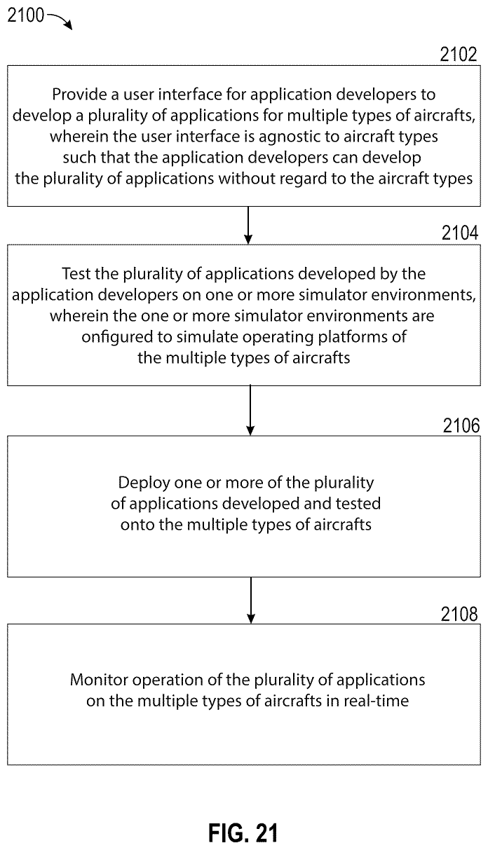

FIG. 21 is a flowchart illustrating a method for operating a platform for deploying, executing, and managing software services on aircrafts in accordance with various embodiments of the present technology. The method 2100 is described in greater detail below with reference to solution 18.
18. A method for operating a platform for deploying, executing, and managing software services on aircrafts, the method comprising: providing a user interface for application developers to develop a plurality of applications for multiple types of aircrafts, wherein the user interface is agnostic to aircraft types such that the application developers can develop the plurality of applications without regard to the aircraft types (2102); testing the plurality of applications developed by the application developers on one or more simulator environments, wherein the one or more simulator environments are configured to simulate operating platforms of the multiple types of aircrafts (2104); deploying one or more of the plurality of applications developed and tested onto the multiple types of aircrafts (2106); and monitoring operation of the plurality of applications on the multiple types of aircrafts in real-time (2108).
19. The method of solution 18, further comprising certifying select ones of the plurality of applications that have passed testing on the one or more simulator environments, wherein the one or more of the plurality of applications deployed onto the multiple types of aircrafts correspond to the select ones of the plurality of applications that have been certified.
20. The method of solution 18 or solution 19, wherein testing the plurality of applications comprises testing the plurality of applications for (i) functionality, (ii) integration with the multiple types of aircrafts, and (iii) performance/stress.
21. The method of solutions 18-20, wherein deploying the one or more of the plurality of applications comprises deploying the one or more of the plurality of applications over-the-air (OTA).
22. The method of solutions 18-21, further comprising: providing a plurality of tenant spaces each dedicated to hosting one or more services associated with an in-flight entertainment (IFE) provider, an in-flight communications (IFC) provider, and/or an airline; providing a virtual infrastructure including virtual compute resources, virtual storage, and a virtual network; and operating the plurality of tenant spaces on the virtual infrastructure within an aircraft.
23. The method of solution 22, further comprising mapping the virtual compute resources, the virtual storage, and the virtual network of the virtual infrastructure onto hardware resources of a plurality of headend servers onboard the aircraft.

124. The method of solution 22 or solution 23, further comprising: detecting a hardware failure of one or more of a plurality of compute/storage modules onboard the aircraft; identifying one or more workloads handled by the one or more of the plurality of compute/storage modules; and reallocating the identified one or more workloads onto other ones of the plurality of compute/storage modules onboard the aircraft, wherein the plurality of tenant spaces remains unaware of the hardware failure.
25. A virtualized development platform 1320 for developing an in-flight entertainment and communications (IFEC) system on aircrafts, the virtualized development platform comprising: a developer portal 1322 providing a user interface for applications developers to develop a plurality of applications; a simulator environment 1324 configured to (i) simulate one or more airside platforms onboard multiple types of aircrafts and (ii) test the plurality of applications developed via the developer portal; and a fleet management unit 1328 configured to deploy the plurality of applications developed via the developer portal and tested via the simulator environment to the multiple types of aircrafts, wherein the virtualized development platform is configured to facilitate development of the plurality of applications on the multiple types of aircrafts while remaining aircraft-agnostic to the application developers.
26. The virtualized development platform of solution 25, wherein the developer portal is configured to provide tenant resources, documentation, and/or tooling to the application developers.
27. The virtualized development platform of solution 25 or solution 26, further comprising a plurality of software models corresponding to the multiple types of aircrafts, wherein the developer portal and/or the simulation environment is configured to facilitate development and/or testing of the plurality of applications on the multiple types of aircrafts by accessing computing and hardware resources of the multiple types of aircrafts via one or more application programming interfaces associated with the plurality of software models.

### 10. Concluding Remarks

It will be appreciated that the present document discloses various techniques and hardware components that can be used to implement a software platform that provides an end-to-end ecosystem for aircraft OEMs (original equipment manufacturers), airlines, partners and 3rd parties to build applications and services that support in-cabin and inflight services and operations using cloud native edge computing technologies. The platform ecosystem is composed of 3 main components-edge compute PaaS (Platform as a Service) on the aircraft, ground side Development Platform along with ground side monitoring and operations center. The platform is an end-end cloud native development platform that can be used build, test, deploy, monitor and operate applications on the aircraft.

It will further be appreciated that the platform along with hardware supports key tenants of cloud computing such as horizontal scaling, high availability and reliability while providing the application provider freedom to use any of the open-source web based and mobile based technologies to build applications. The unique capability of the development platform is a full virtualized aircraft development environment that provides DevSecOps capabilities enabling a CI/CD for development teams integrated with industry standard tooling.

Additional details regarding virtualized platforms and, in particular, virtualized platforms on aircraft are provided (1) in U.S. Pat. No. 11,474,929, titled “Virtualization of complex networked embedded systems,” and filed on Nov. 26, 2019, and (2) in U.S. Pat. No. 11,606,583, titled “Distributed data storage for in-vehicle entertainment system,” and filed on Jun. 8, 2022, the disclosures of which are incorporated by reference herein in their entireties. To the extent any material incorporated herein by reference conflicts with the present disclosure, the present disclosure controls.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer-or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this patent document.

What is claimed is:

1. A service platform for deploying, executing, and managing software services on an aircraft, the platform comprising:
an airside platform onboard an aircraft, wherein the airside platform is configured to host a plurality of applications and store a plurality of media files via edge caching;
a development platform including:
a developer portal providing a user interface for applications developers to develop the plurality of applications,
a simulator environment configured to simulate the airside platform and test the plurality of applications developed via the developer portal, and
a deployment unit configured to deploy the plurality of applications developed via the developer portal and tested via the simulator environment to the airside platform; and
an operations platform configured to provide the plurality of media files to the airside platform and monitor each of the airside platform and the development platform,
wherein the virtualization system is configured to facilitate development and deployment of the plurality of applications on multiple types of aircrafts while remaining aircraft-agnostic to the application developers.

2. The service platform of claim 1, wherein the airside platform includes:
a plurality of tenant spaces each dedicated to hosting one or more services associated with an in-flight entertainment (IFE) provider, an in-flight communications (IFC) provider, and/or an airline; and
a virtual infrastructure including virtual compute resources, virtual storage, and a virtual network, wherein the plurality of tenant spaces operate on the virtual infrastructure.

3. The service platform of claim 2, wherein the tenant spaces are secured isolated from one another.

4. The service platform of claim 2, wherein the airside platform further includes:
a tenant manager configured to configure and monitor the plurality of tenant spaces; and
an infrastructure manager configured to configure and monitor the virtual infrastructure.

5. The service platform of claim 1, wherein:
the aircraft includes a plurality of headend servers, and
the airside platform includes:
a plurality of tenant spaces each dedicated to hosting one or more services,
a virtual infrastructure including virtual compute resources, virtual storage, and a virtual network, wherein the plurality of tenant spaces operate on the virtual infrastructure, and
an infrastructure manager configured to map the virtual compute resources, the virtual storage, and the virtual network of the virtual infrastructure onto hardware resources of the plurality of headend servers onboard the aircraft.

6. The service platform of claim 5, wherein:
the plurality of headend servers including a plurality of compute/storage modules,
in an event of a hardware failure of one or more of the plurality of compute/storage modules, the infrastructure manager is configured to reallocate the virtual compute resources, the virtual storage, and the virtual network of the virtual infrastructure onto remaining ones of the plurality of compute/storage modules, and
the plurality of tenant spaces remains unaware of the hardware failure.

7. The service platform of claim 1, wherein the deployment unit of the development platform includes a fleet management architecture configured to deploy the plurality of applications developed via the developer portal and tested via the simulator environment to multiple airside platforms of multiple different aircrafts via over-the-air (OTA) deployment.

8. The service platform of claim 7, wherein the fleet management architecture includes (i) a fleet, services, and package workload management unit, (ii) a package delivery and OTA unit, (iii) an inventory management unit, (iv) an operational visualization, analytics, and reporting unit, and (v) an operational monitoring and logs management unit.

9. The service platform of claim 1, wherein the developer portal of the development platform is configured to provide tenant resources, documentation, and/or tooling to the application developers.

10. The service platform of claim 1, wherein the development platform includes a plurality of software models corresponding to the multiple types of aircrafts, and wherein the platform is configured to facilitate the development and deployment of the plurality of applications on the multiple types of aircrafts by accessing computing and hardware resources of the multiple types of aircrafts via one or more application programming interfaces associated with the plurality of software models.

11. A method for operating a platform for deploying, executing, and managing software services on aircrafts, the method comprising:
providing a user interface for application developers to develop a plurality of applications for multiple types of aircrafts, wherein the user interface is agnostic to aircraft types such that the application developers can develop the plurality of applications without regard to the aircraft types;
testing the plurality of applications developed by the application developers on one or more simulator environments, wherein the one or more simulator environments are configured to simulate operating platforms of the multiple types of aircrafts;
deploying one or more of the plurality of applications developed and tested onto the multiple types of aircrafts; and
monitoring operation of the plurality of applications on the multiple types of aircrafts in real-time.

12. The method of claim 11, further comprising certifying select ones of the plurality of applications that have passed testing on the one or more simulator environments, wherein the one or more of the plurality of applications deployed onto the multiple types of aircrafts correspond to the select ones of the plurality of applications that have been certified.

13. The method of claim 11, wherein testing the plurality of applications comprises testing the plurality of applications for (i) functionality, (ii) integration with the multiple types of aircrafts, and (iii) performance/stress.

14. The method of claim 11, wherein deploying the one or more of the plurality of applications comprises deploying the one or more of the plurality of applications over-the-air (OTA).

15. The method of claim 11, further comprising:
providing a plurality of tenant spaces each dedicated to hosting one or more services associated with an in-flight entertainment (IFE) provider, an in-flight communications (IFC) provider, and/or an airline;
providing a virtual infrastructure including virtual compute resources, virtual storage, and a virtual network; and
operating the plurality of tenant spaces on the virtual infrastructure within an aircraft.

16. The method of claim 15, further comprising mapping the virtual compute resources, the virtual storage, and the virtual network of the virtual infrastructure onto hardware resources of a plurality of headend servers onboard the aircraft.

17. The method of claim 15, further comprising:
detecting a hardware failure of one or more of a plurality of compute/storage modules onboard the aircraft;
identifying one or more workloads handled by the one or more of the plurality of compute/storage modules; and
reallocating the identified one or more workloads onto other ones of the plurality of compute/storage modules onboard the aircraft, wherein the plurality of tenant spaces remains unaware of the hardware failure.

18. A virtualized development platform for developing an in-flight entertainment and communications (IFEC) system on aircrafts, the virtualized development platform comprising:
a developer portal providing a user interface for applications developers to develop a plurality of applications;
a simulator environment configured to (i) simulate one or more airside platforms onboard multiple types of aircrafts and (ii) test the plurality of applications developed via the developer portal; and
a fleet management unit configured to deploy the plurality of applications developed via the developer portal and tested via the simulator environment to the multiple types of aircrafts,
wherein the virtualized development platform is configured to facilitate development of the plurality of applications on the multiple types of aircrafts while remaining aircraft-agnostic to the application developers.

19. The virtualized development platform of claim 18, wherein the developer portal is configured to provide tenant resources, documentation, and/or tooling to the application developers.

20. The virtualized development platform of claim 18, further comprising a plurality of software models corresponding to the multiple types of aircrafts, wherein the developer portal and/or the simulation environment is configured to facilitate development and/or testing of the plurality of applications on the multiple types of aircrafts by accessing computing and hardware resources of the multiple types of aircrafts via one or more application programming interfaces associated with the plurality of software models.
